(19) United States
(12) Patent Application Publication
(10) Pub. No.: US 2009/0122967 A1
(43) Pub. Date: May 14, 2009

(54) Telephone communication system and method for transmitting reply messages

(76) Inventors: Jan M. Loisch, Kokomo, IN (US); Harry Diamond, Tipton, IN (US)

Correspondence Address: DELPHI TECHNOLOGIES, INC., M/C 480-410-202, PO BOX 5052, TROY, MI, 48007, US

(21) Appl. No.: 11/983,250

(22) Filed: Nov. 8, 2007

(51) Int. Cl. H04M 11/00

(52) U.S. Cl. 379/93.01

(57) ABSTRACT

A telephone communication system and method for transmitting reply messages are provided. The telephone communication system includes a plurality of telephone devices, wherein at least a first telephone device has hardware circuitry, a display, and a processor. The hardware circuitry receives a signal from a second telephone device. The display is in communication with the hardware circuitry and displays an image when the signal is received. The processor is in communication with the hardware circuitry and the display, and the processor performs the steps including communicating the image that is displayed on the display when the signal is received, wherein at least one prerecorded reply message is made available for selection when the signal is received, and receiving a command inputted by a user of the first telephone device selecting one of the available reply messages, wherein the selected reply message is transmitted to the second telephone device.

### TECHNICAL FIELD

The present invention generally relates to a system and method of telephone communication, and more particularly, to a system and method of telephone communication, wherein reply messages are transmitted.

### BACKGROUND OF THE DISCLOSURE

Generally, telephones are used for communication between two parties at one particular time. However, at times during the communication between the two parties, a third party can attempt to communicate with one of the two parties of the original telephone communication. There have been developments in order to communicate with a third party under such circumstances; however, these developments typically require an interruption between the two parties in the original communication.

One example of such a development is a call-waiting option, wherein the party in the original communication is typically notified that a third party is attempting to communicate with them. Generally, the party that receives the notification has the option of ignoring the notification, or interrupting the original communication to answer the communication with the third party. Another example of such a development is three-way calling, wherein multiple parties in multiple locations using multiple telephones typically can all communicate within a single conversation. However, the three-way calling generally requires that all the parties to the conversation be involved in the discussed subject matter.

Additionally, automated answering systems have been developed for answering a call when a person is unavailable, such as when the person is not within the vicinity of the telephone. One example of an automated answering device is an answering machine or voice mail, wherein a person generally prerecords a message, which all parties that access the automated answering system hear prior to being able to leave their message.

Generally, another development is where a party cannot answer a call from another party, but sends the other party a text message. Typically, the party must type out the text message at the time the call is received, and thus, the other party typically does not receive the message prior to being directed to the party's voice or text mail system, wherein the party's standard voice mail message is communicated.

### SUMMARY OF THE INVENTION

According to one aspect of the present invention, a telephone system for transmitting reply messages includes a plurality of telephone devices, wherein at least a first telephone device of the plurality of telephone devices has hardware circuitry and a display. The hardware circuitry receives a signal from a second telephone device of the plurality of telephone devices. The display is in communication with the hardware circuitry and displays an image when the signal is received. A processor is in communication with the hardware circuitry and the display, and the processor performs the steps including communicating with the hardware circuitry to display the image on the display when the signal is received, wherein at least one prerecorded reply message is available for selection when the signal is received, and receiving a command inputted by a user of the first telephone device selecting one of the available reply messages, wherein the selected reply message is transmitted to the second telephone device.

According to another aspect of the present invention, a method of communicating a reply message with a telephone device in a telephone communication system includes the steps of receiving with a first telephone device a signal transmitted from a second telephone device, displaying an image on a display of the first telephone device when a signal is received by the first telephone device, and making at least one prerecorded reply message available for selection when a signal is received. The method further includes the steps of selecting one of the available reply messages, and transmitting the selected reply message to the second telephone device.

According to yet another aspect of the present invention, a method of communicating a reply message with a telephone device in a telephone communication system includes the steps of receiving with a first telephone device a signal transmitted from a second telephone device, wherein the first telephone device is communicating with a third telephone device when the signal is received from the second telephone device, displaying an image on a display of the first telephone device when a signal is received by the first telephone device, making at least one prerecorded reply message available for selection when the signal is received, wherein the at least one available reply message is displayed on the display, and selecting one of the available reply messages. The method further includes the steps of transmitting the selected reply message to the second telephone device, wherein the transmitted reply message is at least one of an automated voice message, a voice message, a text message, a canned text message, a picture message, and a video message, and setting an alarm to be activated at the expiration of a predetermined period of time, wherein the predetermined period of time is dependent upon the selected reply message.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is an environmental view of a telephone communication system, in accordance with one embodiment of the present invention;

FIG. 2 is a block diagram of a telephone device in a telephone communication system, in accordance with one embodiment of the telephone device of the present invention;

FIG. 3 is a flow chart illustrating a method of communicating a reply message with a telephone device in a telephone communication system, in accordance with one embodiment of the present invention;

FIG. 4 is a flow chart illustrating an exemplary software routine implemented by a processor, according to one embodiment of the present invention; and

FIG. 5 is a flow chart illustrating an exemplary method of transmitting a default reply message, according to one embodiment of the present invention.

### DETAILED DESCRIPTION OF THE PREFERRED EMBODIMENTS

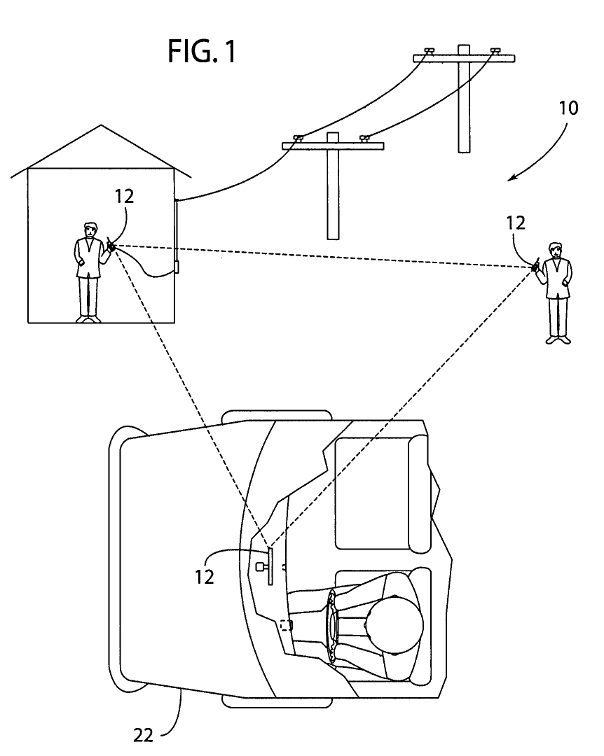

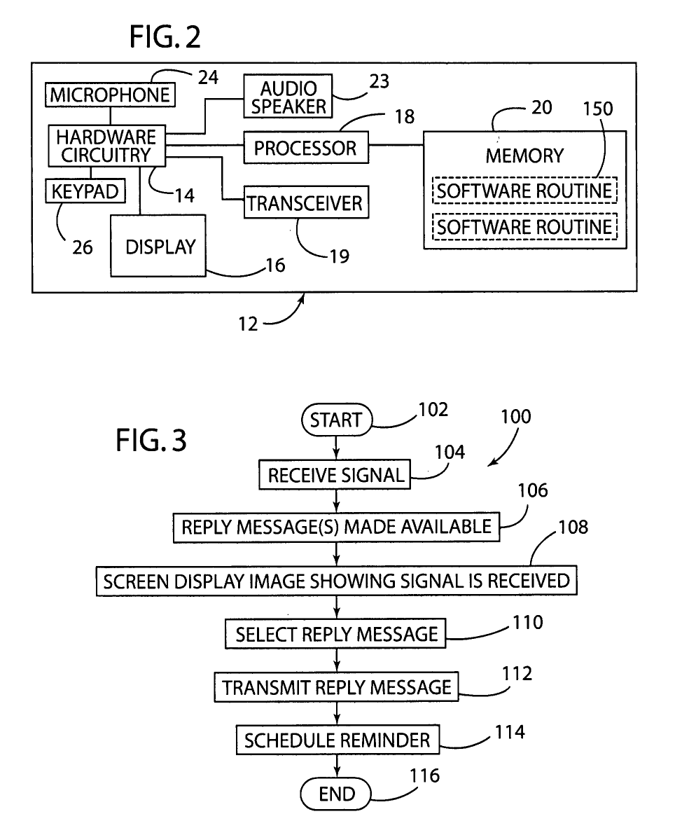

In reference to both FIGS. 1 and 2, a telephone communication system is generally shown in FIG. 1 at reference identifier 10. The telephone communication system 10 includes a plurality of telephone devices 12, wherein at least one of the plurality of telephone devices 12 includes hardware circuitry 14 that receives and transmits a signal. The at least one of the plurality of telephone devices 12 further includes a display or screen 16. Typically, the display 16 is in communication with the hardware circuitry 14, such that the display 16 displays an image when the signal is received. A processor 18 is in communication with the hardware circuitry 14 and the display 16, and performs one or more steps for transmitting a prerecorded reply message when a signal is received, as described in greater detail herein. According to one embodiment, the telephone device 12 includes a transceiver 19 for receiving and transmitting signals.

For purposes of explanation and not limitation, each of the telephone devices 12 can be any of a landline telephone, a cellular telephone, or a telephone integrated with a vehicle 22. The telephone devices 12 can provide service from a landline telephone service provider, a cellular telephone service provider, a Voice over Internet Protocol (VoIP) telephone service provider, two-way communication provider, one or more software routines implemented by a hardware device (i.e., a computer readable medium or the like), the like, or a combination thereof. According to one embodiment, the telephone device 12 integrated with the vehicle 22 can be a telephone included in the ON-STAR™ system. Alternatively or additionally, the telephone device 12 that is integrated with the vehicle 22 can be placed in communication with a vehicle's audio system, such as, but not limited to, a wireless BLUETOOTH™ connection, according to one embodiment.

According to one embodiment, the processor 18 is included in the telephone device 12. Alternatively, the processor 18 is included in the telephone communication system 10 and separate from the hardware circuitry 14 of at least one of the telephone devices 12. Typically, the processor 18 can execute one or more software routines in order to perform the steps for communicating the reply message in response to a received signal. Additionally, the processor 18 can be in communication with a memory device 20, which can be used to store the one or more software routines, or other desirable data. By way of explanation and not limitation, the memory device 20 can be volatile memory devices, such as a random access memory (RAM) device or the like, non-volatile memory devices, such as a read-only memory (ROM) device, electronically erasable programmable read-only memory (EEPROM), flash memory, or the like, or a combination of volatile and non-volatile devices.

The processor 18 communicates an image that is displayed on the display 16 when the signal is received. Additionally, the processor 18 renders at least one reply message available for selection when the signal is received. When the processor 18 receives a command selecting one of the available reply messages, the selected reply message is transmitted to an originator (i.e., a user of a second telephone device) of the received signal. According to one embodiment, the user can be required to confirm the selection of the available reply message prior to the reply message being sent. For purposes of explanation and not limitation, the originator can be a user of a second telephone device within the telephone communication system 10 that is in communication with a first telephone device, such that signals are being communicated between the first and second telephone devices. The displayed image can include desirable information, such as, but not limited to, identifying the originator, the available reply messages, the like, or a combination thereof. It should be appreciated by those skilled in the art that the originator can be identified by other distinguishing features, such as, but not limited to, a ring-tone corresponding to a particular originator, or the like.

Typically, the available reply messages differ so that when communicated, desirable information is communicated to the recipient of the reply message, as described in greater detail below. Thus, a user of the telephone device 12 can prerecord multiple reply messages, so that when the reply messages are made available, the user has a variety of reply messages to choose from, according to one embodiment. By way of explanation and not limitation, one of the available reply messages can communicate the message “I will call you back in thirty minutes.” Thus, the user of the telephone device 12 communicates selected useful information to the recipient of the reply message, rather than a standard message that is non-specific to the user or current circumstances, being communicated when the user of the telephone device 12 does not answer. The selected reply message thus communicates useful information that is relevant to that particular recipient at that particular time.

According to one embodiment, the telephone device 12 being contacted by the originator will continue to ring until the telephone device 12 is answered or a reply message is selected and communicated or transmitted to the originator. Additionally or alternatively, if the user of the telephone device 12 knows he/she will not have access to the telephone device 12 for a period of time, the user can select a prerecorded reply message to be communicated to the originator after a predetermined number of rings, according to one embodiment. According to an alternate embodiment, the telephone device 12 has a default reply message that is communicated to the originator after a predetermined number of rings, unless one of the available reply messages is selected. Thus, the reply messages can be prerecorded so that the reply message can be communicated to the originator within the time period that the originator would anticipate being directed to a voice mail or message system.

Additionally, the processor 18 can set an alarm to be activated at the expiration of a predetermined period of time, wherein the predetermined period of time is dependent upon the selected reply message, according to one embodiment. Thus, when the exemplary reply message of “I will call you back in thirty minutes” is selected and communicated to the originator, the processor 18 can set an alarm for thirty (30) minutes. Thus, at the expiration of the period of time, the alarm can be activated as a reminder to the user of the telephone device 12 to call the recipient of the reply message. According to one embodiment, when the processor 18 is included in the hardware circuitry 14, the processor 18 executes one or more software routines to activate a component on the telephone device 12 to alert the user. According to an alternate embodiment, when the processor 18 is separate from the hardware circuitry 14, the processor 18 executes one or more software routines, such that a signal is communicated to the telephone device 12 to alert the user. Typically, the predetermined period of time is based upon the selected reply message, and, thus, the processor 18 can activate the alarm to remind the user of the telephone device 12 after differing periods of time, depending upon which reply message had been selected and communicated. For purposes of explanation and not limitation, the alarm can be an audio alarm emitted from an audio speaker 23, or a vibration device that vibrates the telephone device 12, according to one embodiment.

By way of explanation and not limitation, the prerecorded transmitted reply message can be an automated voice message, a voice message, a text message, a canned text message, a picture message, a video message, the like, or a combination thereof. Thus, if an automated voice message is used, the provider of the telephone device 12 or message service can provide a variety of prerecorded automated or canned voice messages, which can be preselected as available reply messages, according to one embodiment. According to one embodiment, if a canned text message is used, the provider of the telephone device 12 or message service can provide a variety of canned text messages, which can be preselected as available reply messages. Additionally or alternatively, a user of the telephone device 12 can prerecord voice messages or video messages, which can be used as the available reply message, according to one embodiment.

According to one embodiment, the command for selecting one of the available reply messages can be a voice command, a touch screen command, a keypad command, or the like. Thus, the telephone device 12 can include a microphone 24 for receiving a voice command. Alternatively or additionally, the display 16 can be a touch screen for receiving a touch screen command. Additionally, a keypad 26 can be used for entering other data into the telephone device 12 and receive the command for selecting a reply message, according to one embodiment.

Additionally or alternatively, one or more default reply messages can be corresponding to an originator or group of originators, such that a selective do-not-disturb can be implemented, so that the corresponding default reply message is immediately transmitted to the originator without the user of the first telephone device being notified that the originator is contacting the user. By way of explanation and not limitation, a first group of originators, such as family members, can be designated, while a second group of originators, such as business contacts, can be designated. The second group can be selected for immediate routing to a corresponding default reply message, such that the user of the first telephone device is not notified that an originator from the second group is attempting to contact them. Further, the user of the first telephone device is notified that an originator from the first group is attempting to contact them, such that the user of the first telephone device can communicate with the originator, select and transmit an available reply message, allow a predetermined default reply message to be transmitted to the originator, or the like.

In reference to FIGS. 1-3, a method of communicating a reply message with the telephone device 12 in the telephone communication system 10 is generally shown in FIG. 3 at reference identifier 100. The method 100 starts at step 102, and proceeds to step 104, wherein the signal is received by the telephone device 12. The available reply messages are made available at step 106. At step 108, the display 16 displays an image showing that the signal is received. According to one embodiment, the display 16 also displays an image that shows at least a portion of the available reply messages. Additionally, the display 16 can include an image that indicates who the originator or caller is, when the first telephone device receives a signal. It should be appreciated by those skilled in the art that the originator can be identified using other distinguishing features, such as, but not limited to, a ring-tone associated with a particular originator or telephone number.

At step 110, a reply message is selected. According to one embodiment, a command is entered by a user of the telephone device 12 in order to select the reply message, wherein the received command can be one of a voice command, a touch screen command, and a keypad command. The selected reply message is transmitted at step 112. According to one embodiment, the processor 18 can schedule a reminder based upon the selected reply message at step 114. After step 112 and step 114, the method 100 then ends at step 116.

By way of explanation and not limitation, a first user of a first telephone device in the telephone communication system 10 is communicating with a third user using a third telephone device in the telephone communication system 10 when a second user of a second telephone device of the telephone communication system 10 (i.e., the originator) contacts the first user, and thus, transmits a signal from the second user's telephone device 12 to the first user's telephone device 12, according to one embodiment. When the first user's telephone device 12 receives the signal, the reply messages are made available. The first user can then select one of the available reply messages that is to be transmitted to the second user. Thus, if the first user is on a conference call that will last another hour, the reply message can inform the second user of the situation. Alternatively, if the first user will be unavailable for the remainder of the day, the selected reply message can inform the second user of the situation. Thus, the reply messages can be unique to the situation and/or the user that is receiving the reply message. For purposes of explanation and not limitation, the available reply messages can be unique to other users of the telephone communication system 10, such that a portion of the available reply messages would be communicated to a family member rather than a co-worker.

According to one embodiment, the first user of the telephone communication system 10 is not using the first telephone device when receiving a signal from a second user of a second telephone device. However, if the first user of the first telephone device does not desire to answer the telephone call, the first user can select a reply message on the first telephone device that is then transmitted to the second user of the second telephone device, such as, “I am at the movie theater—call you in an hour.” Thus, the user can communicate information that is applicable to the receiver of the reply message (i.e., the second user) and/or the current situation without being required to answer the call.

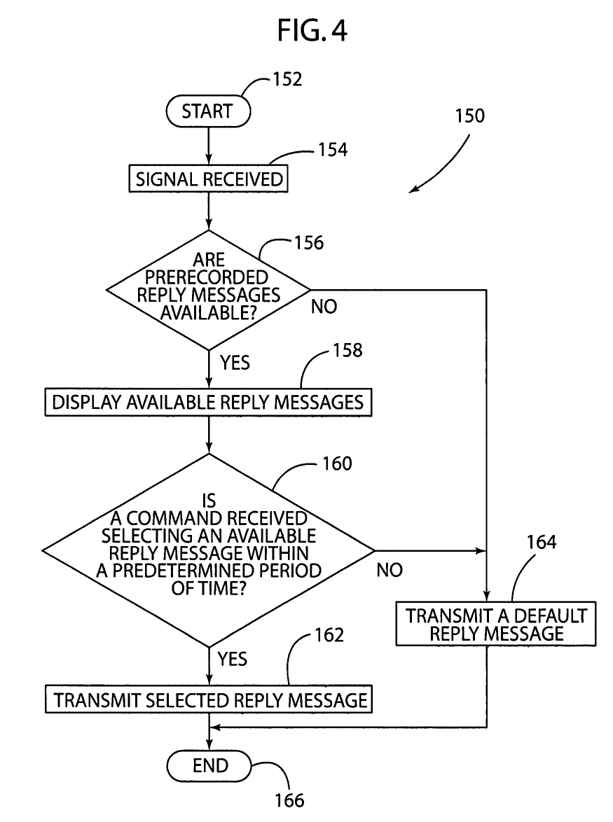

With respect to FIGS. 1, 2, and 4, an exemplary software routine is generally shown in FIG. 4 at reference identifier 150. The software routine 150 starts at step 152, and proceeds to step 154, wherein a signal is received. According to one embodiment, the signal is received by the first telephone device from the second telephone device. In an alternate embodiment, the first telephone device is communicating with the third telephone device when the signal is received from the second telephone device. At decision step 156, it is determined if prerecorded reply messages are available. If it is determined at decision step 156 that there are prerecorded reply messages that can be made available, then the software routine 150 proceeds to step 158, wherein the available reply messages are displayed. Typically, the available reply messages are displayed on the display 16.

According to one embodiment, at decision step 160, it is determined if a command has been received selecting an available reply message within a predetermined period of time. According to one embodiment, a user of the first telephone device selects an available reply message using a touch screen, a keypad, a voice command, or the like. If it is determined at decision step 160 that a command is received selecting an available reply message, then the software routine 150 proceeds to step 162, wherein the selected reply message is transmitted. According to one embodiment, the selected reply message is transmitted to the second telephone device.

If it is determined at decision step 156 that there are no prerecorded reply messages available, or it is determined at decision step 160 that a reply message was not selected within the predetermined period of time, then the software routine 150 proceeds to step 164, wherein a default reply message is transmitted. According to one embodiment, the default reply message is transmitted to the second telephone device. Additionally or alternatively, there can be multiple default reply messages, such that a person or group of people can be designated to receive a particular reply message. By way of explanation and not limitation, a first group, such as family members, can be designated to receive a first default reply message, while a second group, such as business contacts, can be designated to receive a second default reply message. The software routine 150 then ends at step 166.

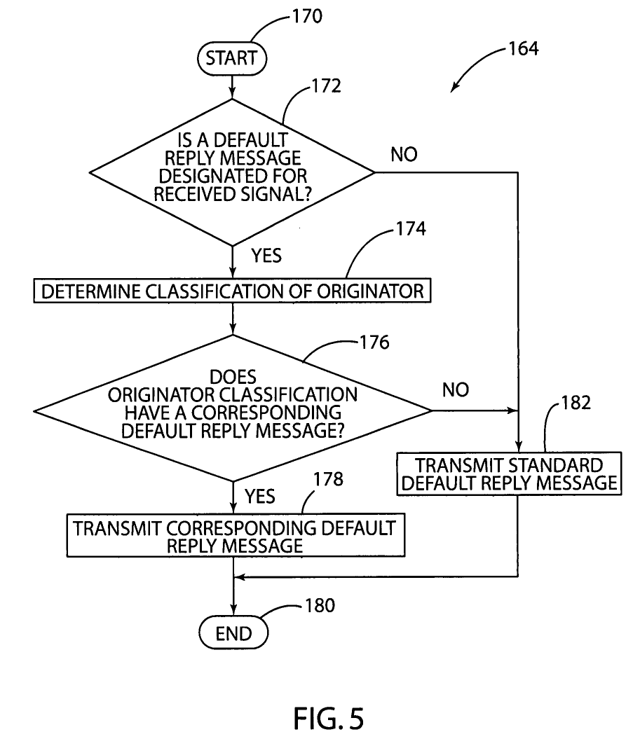

In reference to FIGS. 1-2 and 4-5, an exemplary method for transmitting a default reply message is generally shown in FIG. 5 at reference identifier 164. The method 164 starts at step 170, and proceeds to step 172, wherein it is determined if a default reply message is designated for a received signal. According to one embodiment, it is determined if contacts, such as, but not limited to, family members, business contacts, the like, or a combination thereof, are designated in groups (i.e., using caller-ID) to receive a corresponding default reply message. If it is determined at decision step 172 that a default reply message is designated for a received signal, then the method 164 proceeds to step 174, wherein the classification of the originator is determined.

At decision step 176, it is determined if the originator classification has a corresponding default reply message, which is typically predetermined by the user of the first telephone device, according to one embodiment. If it is determined at decision step 176 that the originator classification has a corresponding default reply message, then the method 164 proceeds to step 178, wherein the corresponding default reply message is transmitted. The method 164 can then end at step 180.

However, if it is determined at decision step 172 that a default reply message is not designated for a received signal, then the method 164 proceeds to step 182, wherein a standard default reply message is transmitted. According to one embodiment, a standard default reply message is a predetermined reply message that is transmitted to all originators when the circumstances permit the default reply message be transmitted, or a reply message that is designated to be sent to originators that do not have a classification with a corresponding default reply message. Further, if it is determined at decision step 176 that the originator classification does not have a corresponding default reply message, then the method 164 proceeds to step 182, wherein the standard default reply message is transmitted. The method 164 can then end at step 180.

Advantageously, the user of a telephone device 12 in a telephone communication system 10 can transmit prerecorded reply messages that communicate specific information to another party based upon the current circumstances, rather than the other party hearing a generic voice mail message, and not receiving any information as to when they might be able to contact the user. Additionally, a variety of reply messages can be prerecorded or preset, such that the user can have different options for selecting the reply message based upon the current circumstances. Further, the telephone device 12 can schedule reminders based upon the selected reply messages in order to remind the user of the previously sent reply message.

The above description is considered that of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A telephone communication system for transmitting reply messages, comprising:
a plurality of telephone devices, wherein at least a first telephone device of said plurality of telephone devices comprises:
hardware circuitry that receives a signal from a second telephone device of said plurality of telephone devices; and
a display in communication with said hardware circuitry, wherein said display displays an image when said signal is received; and
a processor in communication with said hardware circuitry and said display, wherein said processor performs the steps comprising:
communicating with said hardware circuitry to display said image, such that said image is displayed on said display when said signal is received, wherein at least one prerecorded reply message is made available for selection when said signal is received; and
receiving a command inputted by a user of said first telephone device selecting one of said available reply messages, wherein said selected reply message is transmitted to said second telephone device.

2. The telephone communication system of claim 1, wherein said processor further performs the step comprising setting an alarm to be activated at the expiration of a predetermined period of time, wherein said predetermined period of time is dependent upon said selected reply message.

3. The telephone communication system of claim 1, wherein said transmitted reply message is at least one of an automated voice message, a voice message, a text message, a canned text message, a picture message, and a video message.

4. The telephone communication system of claim 1, wherein said received command is one of a voice command, a touch screen command, and a keypad command.

5. The telephone communication system of claim 1, wherein said processor provides a predetermined period of time to select said reply message, and if no said reply message is selected within said predetermined period of time, then a default reply message is transmitted to said second telephone device.

6. The telephone communication system of claim 1, wherein said first telephone device is at least one of a landline telephone, a cellular telephone, a telephone integrated with a vehicle, a Voice over Internet Protocol (VoIP) telephone, and a two-way communication telephone, at least one software routine implemented by a hardware device.

7. The telephone communication system of claim 1, wherein said first telephone device further comprises said processor, such that said first telephone device transmits said reply message.

8. The telephone communication system of claim 1, wherein said processor is included in said telephone communication system and separate from said hardware circuitry of at least one of said plurality of telephone devices.

9. A method of communicating a reply message with a telephone device in a telephone communication system, said method comprising the steps of:
receiving with a first telephone device a signal transmitted from a second telephone device;
displaying an image on a display of said first telephone device when a signal is received by said first telephone device;
making at least one prerecorded reply message available for selection when said signal is received;
selecting one said available reply message; and
transmitting said selected reply message to said second telephone device.

10. The method of claim 9 further comprising the step of setting an alarm to be activated at the expiration of a predetermined period of time, wherein said predetermined period of time is dependent upon said selected reply message.

11. The method of claim 9 further comprising the step of transmitting a default reply message to said second telephone device if one of said available reply messages is not selected within a predetermined period of time.

12. The method of claim 9, wherein said transmitted reply message is at least one of an automated voice message, a voice message, a text message, a canned text message, a picture message, and a video message.

13. The method of claim 9, wherein said received command is one of a voice command, a touch screen command, and a keypad command.

14. The method of claim 9, wherein said first telephone device is at least one of a landline telephone, a cellular telephone, a telephone integrated with a vehicle, a Voice over Internet Protocol (VoIP) telephone, and a two-way communication telephone, at least one software routine implemented by a hardware device.

15. The method of claim 9 further comprising the step of using said first telephone device to communicate with a third user of a third telephone device when said signal is received from said second telephone device that renders said at least one reply message available.

16. The method of claim 9 further comprising the step of a user of said first telephone device not using said first telephone device when said signal is received from said second telephone device that renders said at least one reply message available.

17. A method of communicating a reply message with a telephone device in a telephone communication system, said method comprising the steps of:
receiving with a first telephone device a signal transmitted from a second telephone device, wherein said first telephone device is communicating with a third telephone device when said signal is received from said second telephone device;
displaying an image on a display of said first telephone device when a signal is received by said first telephone device;
making at least one prerecorded reply message available for selection when said signal is received, wherein said at least one available reply message is displayed on said display;
selecting one said available reply message within a predetermined period of time;
transmitting said selected reply message to said second telephone device, wherein said transmitted reply message is at least one of an automated voice message, a voice message, a text message, a canned text message, a picture message, and a video message; and
setting an alarm to be activated at the expiration of a predetermined period of time, wherein said predetermined period of time is dependent upon said selected reply message.

18. The method of claim 17, wherein said first telephone device is at least one of a landline telephone, a cellular telephone, a telephone integrated with a vehicle, a Voice over Internet Protocol (VoIP) telephone, and a two-way communication telephone, at least one software routine implemented by a hardware device.

19. The method of claim 17 further comprising the step of transmitting a default reply message to said second telephone device if one of said available reply messages is not selected within a predetermined period of time, wherein a first predetermined group receives a first default reply message, and a second predetermined group receives a second default reply message.

20. The method of claim 17, wherein said received command is one of a voice command, a touch screen command, and a keypad command.
